(19) United States
(12) Patent Application Publication
(10) Pub. No.: US 2013/0043053 A1
(43) Pub. Date: Feb. 21, 2013

(54) Power Tool for Falsework Assemblies

(71) Applicant: Byrne Bros (Formwork) Ltd, Teddington (GB)

(72) Inventors: Sergio Malorni, Windsor (GB); Nick Simms, Bexley (GB); Aran Verling, Staines (GB); Robbie Wilson, Harwich (GB)

(73) Assignee: Byrne Bros (Formwork) Ltd, Teddington (GB)

(21) Appl. No.: 13/656,269

(22) Filed: Oct. 19, 2012

Related U.S. Application Data
(63) Continuation of application No. PCT/GB2011/050771, filed on Apr. 19, 2011.

(30) Foreign Application Priority Data
Apr. 20, 2010 (GB) 1006555.5

(51) Int. Cl. B23Q 5/04; B23Q 5/10; B23Q 5/12; B23Q 5/06

(52) U.S. Cl. 173/216; 173/213; 173/218; 173/217

(57) ABSTRACT

A power tool is provided for turning the screw collars 7 of falsework without the requirement of having to use spanners with long torque bars and without having to strike those torque bars with hammers or sledgehammers in order to exert the necessary torque on the collars 7. The tool is in two parts. A first part is a screw collar 7, or a collar adapter 10 which can be closed and locked around the screw collar 7 to be turned. The collar 7 or the collar adapter 10 has one or more drive engagement elements 11. The second part is a motor housing 20 supporting a motor 19 and a motor drive element 16 such as a spur gear. The motor housing 20 is formed to take its angular support from a falsework post 1 and its vertical support from either the falsework post 1, the screw collar 7 or the collar adapter 10. The motor 19 drives the motor drive element 16 such as the spur gear which engages the drive engagement element or elements 11 of the screw collar 7 or the collar adapter 10, drivingly to turn the screw collar 7 either directly or by rotation of the collar adapter 10.

### CROSS-REFERENCE TO RELATED PATENT APPLICATIONS

This patent application is a continuation of PCT/GB2011/050771, filed Apr. 19, 2011, which claims priority to Great Britain Application No. 1006555.5, filed Apr. 20, 2010, the entire teachings and disclosure of which are incorporated herein by reference thereto.

### FIELD OF THE INVENTION

The invention relates to the construction and dismantling (herein striking-down or simply “striking”) of falsework in the construction industry. “Falsework” is the name given to the framework for supporting a structure under construction which is not yet capable of supporting itself For example, the structure may be one created by the on-site pouring of wet concrete into a mould supported by the falsework. That mould would be vertically or horizontally supported by the falsework, which typically would comprise an array of posts. Vertical or horizontal posts of the falsework typically are adjustable in length, which can be achieved by having a threaded post positioned relative to its base post by means of adjustment of a screw collar. The falsework would take the load of the mould and ultimately of the wet concrete mix poured into that mould. Once the concrete has set, or once the constructed structure has otherwise been rendered self-supporting, the striking can take place. After the wet concrete has been poured into the moulds, however, the loads on each screw collar of the falsework are potentially very high indeed, making the striking process very difficult. The invention provides a novel power tool for turning screw collars on falsework posts during either the installation or the striking of falsework, but particularly during the striking process.

### BACKGROUND OF THE INVENTION

A falsework post can achieve adjustability in length by having a threaded member inserted into a hollow member where their relative positions are controlled by a screw collar as shown in FIG. 1. The threaded member may have continuous or non-continuous screw threads, of which the latter may be interrupted by features such as flat or shaped surfaces or axial keyway slots which are provided for purposes such as (but not limited to) cleaning and mounting auxiliary falsework components. When a load axial to the post is applied, the screw collar would be under load resulting in friction existing between screw collar, the hollow member and threaded member. To reduce friction, an auxiliary part, such as a low friction plastic component, may be placed between the screw collar and the hollow member.

When an area of falsework is used to support moulds for a massive concrete structure such as a road bridge or an elevated highway, the loads supported by each post of the falsework can be very high indeed. This makes the unscrewing of the individual screw-threaded nuts or collars on the posts during striking a very difficult operation. One collar design comprises an internally screw-threaded cast nut or cylinder with two or four externally projecting lugs which permit a user to grasp and turn the collar to raise or lower it on an externally screw-threaded portion of its post while it is not under load.

The recommended method of freeing tight collars under load during the striking of falsework is to fit a torque bar on the collar and apply a load by hand. When the collar is under load, a torque bar can be coupled to the collar and engaged with some or all of the lugs, in order safely to obtain the necessary leverage to turn the collar. Torque values needed to strike falsework posts on a construction site may be as high as 900 N.m. Using a torque bar approximately 1 metre in length as shown in FIG. 2, that would require a force on or near the free end of the torque bar of over 900 N, which is difficult or impossible to obtain manually especially when working in cramped conditions (i.e. close to other falsework or walls) or with the collar possibly at a height or in a location that is difficult to reach. The collar may be near to the ground if the post has a hollow column member with a threaded member extending downwardly from its lower end, or may be at an elevated position if the post has a screw threaded portion extending axially from its upper end. Posts with screw threaded extension portions at both ends are also known. However with the magnitudes and limitations mentioned above, this method is not sufficient.

Another method of freeing tight collars is to apply an impact load at the free end of the torque bar by hitting it repeatedly with a heavy hammer or sledgehammer. Frequently, however, this is difficult for a number of reasons; (a) the space limitations to install a torque bar may restrict this method, (b) the concurrent holding of a torque bar and the swinging action of a hammer (especially a sledgehammer) is ergonomically difficult, (c) even with a torque bar held securely in place ready for hitting, there may be insufficient room for a proper swing of the hammer and (d) the hammer swinging operation cannot always be performed easily as the site worker may have to swing the hammer from a compromising position (i.e. perched from an access tower or platform.) It is therefore not unusual for workers to omit the torque bar, and attempt to loosen collars by impacting the projecting lugs of the collars directly with a heavy hammer or sledgehammer. This latter operation is also faster to perform compared to having to set up a torque bar—hence direct impacting of the collar tends to be adopted as the only convenient method.

There are several consequences for directly impacting the collars with one or a series of hammer swings. The first consequence is damage to the collars. The collar lugs may become significantly deformed to the point that the collars can no longer accept the torque bar. Likewise the collar may become significantly deformed so that the lugs no longer provide enough surface for a hammer impact to be effective, or the lugs may break off. The collars themselves can also fracture. Therefore replacement and inspection costs for the collars can be significant in order to manage the safety of the falsework.

Another consequence is safety for the site workers. As the torque required to release the load of the collar is high, and the length of the collar lugs are short, this results in the site workers having to apply a series of relatively powerful hammer swings (usually using a sledgehammer). With cramped spaces, and usually having two site workers for the falsework striking operation, there have been several instances where site workers have been accidentally hit by the sledgehammer swinging action.

A third consequence of this method is increased levels of noise. Instead of performing the recommended method of applying a non-impact load on a torque bar, the magnitude of the hammer impact and the frequency of the swings create a level of noise that is significant even for a building site. Especially where concrete building structures are created in urban environments in the vicinity of businesses and residential sites, the series of hits, especially occurring concurrently with other striking, can create a significant disturbance. There have been instances where the United Kingdom Health and Safety Executive have issued notices to construction companies prohibiting them from creating significant noise during the striking of falsework.

A need therefore exists for a tool which can rapidly, safely and reliably turn a post collar even when it is under extreme loads during the striking of falsework, whilst avoiding damage to that collar. A non-impact approach facilitates reduction of collar damage with the added benefit of noise reduction.

### BRIEF SUMMARY OF THE INVENTION

The invention provides a tool for turning a screw collar on a falsework post, as defined in claim 1 herein. The tool is a power tool which removes the need for workers to use a heavy hammer or sledgehammer even when striking falsework which is under extremely heavy loads.

The motor may be hydraulic, pneumatic or electrical. Hydraulic motors are preferred, particularly for tools to be used for the striking of falsework, because they have potentially the best balance between delivering high torques, unit weight and speed of operation. The drive engagement means may be driven by the motor directly or through gearing that delivers increased torque. The use of gearing permits the use of a lower torque, lighter motor, but at the expense of the added weight and bulk of the gearing system.

In the following specific description we will refer to the tool as being used during the striking of falsework. It will of course be understood that the same or a similar tool could be used as a kind of powered nut runner for extending the lengths of the individual posts of the falsework before they are subjected to high axial loads for the creation of concrete structures. If the motor is to act in a direction to extend the length of the individual posts, however, it is preferably torque-limited so that on extension of the posts no serious damage to the falsework components or building structure can occur from over-tightening of the collar adapter. If the tool is to be used only for the striking of falsework, it should be designed with a much higher torque motor, preferably one capable of delivering to the collar through the collar adapter a total torque capable of releasing the loads on the falsework , for example at least 785 N.m. and preferably at least 1000 N.m. If the motor is to act bidirectionally, then a torque limiter to prevent damage to the mould or to the construction project should be included for one direction of motor movement, so that the high torque loads on the collar adapter and collar are obtained only during striking of the falsework.

The screw collar can be designed to include integral drive engagement means for drive engagement with the motor drive. Alternatively the drive engagement means may be formed on a collar adapter that is releasably mounted on a conventional manually adjustable screw collar. Such a collar adapter may fully or partially encompass the circumference of the screw collar. The collar adapter would have one or a number of features, such as gear teeth, pawls or dogs, that would engage with a motor drive, which could take the form of a spur gear. The collar adapter would also have features that would drivingly engage with the collar, for example with the lugs of the collar. When the motor housing is mounted on the falsework post, the motor drive member engages with the drive engagement means on the collar adapter. The collar adapter is preferably constructed to envelop the circumference of the screw collar as the collar may need to rotate for up to several rotations for certain falsework striking operations. Thus the collar adapter may be formed to close and releasably to lock around the screw collar so that when it is closed and locked around the screw collar it partially or completely envelops the screw collar. Once the load has been removed from the collar with the tool, the motor housing can be removed from the falsework post and the collar adapter can be reopened for removal, and both may be reusable for another falsework post.

It is also preferable that the drive engagement means, whether that be on the collar or on a collar adapter, should be as far out from the axis of rotation of the collar as is practicable. That provides maximum torque, and makes it possible to obtain a mechanical advantage of torque multiplication, which in turn allows for a reduced torque being required from the motor.

The collar adapter can be a separate component from the motor and motor housing. However it can be integral should the combined weight of the collar adapter, the drive engagement means, the motor housing and the motor be low enough to be used comfortably by the site worker.

The torque created by the motor would be transmitted to the collar or collar adapter via a motor drive member. The motor drive member can be in the form of a gear, the teeth of which engage with the drive engagement means of the collar or collar adapter. Alternatively the motor drive member may be a single lug or dog acting on one or a few features on the collar or collar adapter.

The torque delivered by the motor drive can originate directly from the motor's output shaft or via a gear-reduction assembly such as a gearbox. The decision for integration of a gearbox would depend on its own weight and cost versus weight and cost savings for using a smaller motor when using a gearbox.

The reaction torque generated on the motor drive by the collar is transmitted from the motor to the motor housing, and thence to the falsework structure. The motor housing takes vertical and angular support from the falsework post, preferably by having constructional details which react against features or the profile surfaces of the non-threaded or the threaded portion of the falsework post. Likewise the tool can react against other rigid and stationary component(s) attached to either the non-threaded or the threaded portion of the falsework post. Thus it is an advantage of the invention that the tool does not require the presence of any adjacent structure that can provide a reaction surface for the application of torque to the collar. No such structure may be present in many falsework assemblies. Adjacent falsework posts, even if present, are not generally designed to provide the lateral reaction force that would be required. Also, if the tool were braced against an adjacent structure, there would exist a problem of backlash, i.e. the potential for movement of the tool into contact with the reaction surface when the motor is actuated, which can cause a crushing injury to the operator.

The attachment of the tool onto the falsework post can either be such that the tool is introduced to the falsework while engaged with the post feature(s) and collar adapter, or clamped on the post.

The tool can be open-framed. The preferred solution is to have no moving parts exposed during operation for safety. Thus the motor housing when mounted on the falsework preferably envelops the collar or collar adapter, avoiding exposure of moving parts. When the motor is first actuated, there may be a relative movement of parts as the drive member comes into contact with the drive engagement means but this movement is confined to the interior of the motor housing. Because the motor housing is angularly immovable relative to the falsework post, the operator is protected from the effects of backlash.

If the tool is closed-framed, means are preferably provided to ensure that the motor housing cannot be closed around the falsework post and around the collar adapter unless the collar adapter, of a type that closes and locks around the collar, is first closed and locked around the collar.

### BRIEF DESCRIPTION OF DRAWINGS

FIG. 1 is schematic perspective view of an array of posts of typical falsework supporting an edifice under construction. FIG. 1 also shows a number of ledgers or cross braces extending between adjacent posts;

FIGS. 2a and 2b are isometric views of a portion of one of the posts of FIG. 1 on an enlarged scale, showing the stationary hollow member portion of the post, the collar and the screw threaded portion of the post in greater detail and also showing a conventional torque bar used for striking the falsework;

FIGS. 3a and 3b are respectively a plan view and a side elevation of typical falsework supporting an edifice under construction, showing the restricted access that is sometimes encountered to make striking difficult;

FIG. 4 is an enlarged detail of a post, the collar and the screw threaded portion of one of the posts of FIGS. 3a and 3b illustrating the use of a sledgehammer to strike the collar when there is insufficient room to use the torque bar of FIGS. 2a and 2b.

FIGS. 5a to 5c are isometric views illustrating the operation of fitting a collar adapter around a collar of falsework when using a tool according to the invention;

FIGS. 6a to 6f are plan views from above illustrating the use of six different collar adapters of tools according to the invention;

FIG. 7 is a plan view from above of the collar adapter of the tool of FIGS. 5a to 5c;

FIGS. 8a to 8c are isometric views of different embodiments of the motor drive;

FIGS. 9a and 9b are isometric views of a tool according to the invention during its installation onto a falsework post;

FIGS. 10a and 10b are horizontal sections taken through a falsework post on which is mounted a motor housing of a tool according to the invention, the motor housings of FIGS. 10a and 10b having different sectional shapes;

FIGS. 11a and 11b are further horizontal sections taken through a falsework post on which is mounted a motor housing of a tool according to the invention, the motor housings of FIGS. 11a and 11b having different sectional shapes;

FIGS. 12 and 13 are isometric views of the tool of FIGS. 9a and 9b but with the motor housing shown more completely and enveloping the collar adapter, avoiding exposure of moving parts;

FIG. 14 is a vertical section through the tool of FIGS. 12a and 13, assembled on a falsework post;

FIGS. 15 and 16 are side elevations of the tool of FIG. 13 (with the access door open) showing the plunger which locks the collar adapter in its fully engaged position (FIG. 15) and a less than fully engaged position (FIG. 16) respectively;

FIG. 17 is a side elevation of another tool according to the invention, mounted on a falsework post; and

FIGS. 18a to 18c are isometric views of three different collars with integral drive engagement means, which do not require separate collar adaptors.

### DETAILED DESCRIPTION OF THE INVENTION

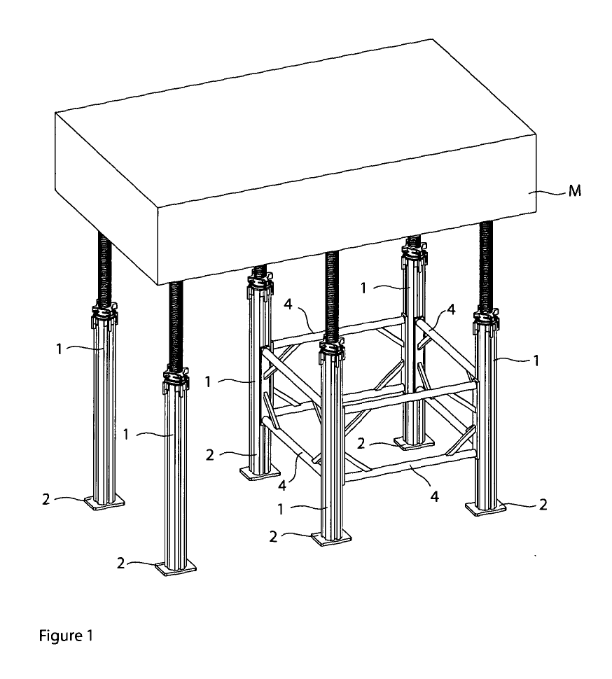

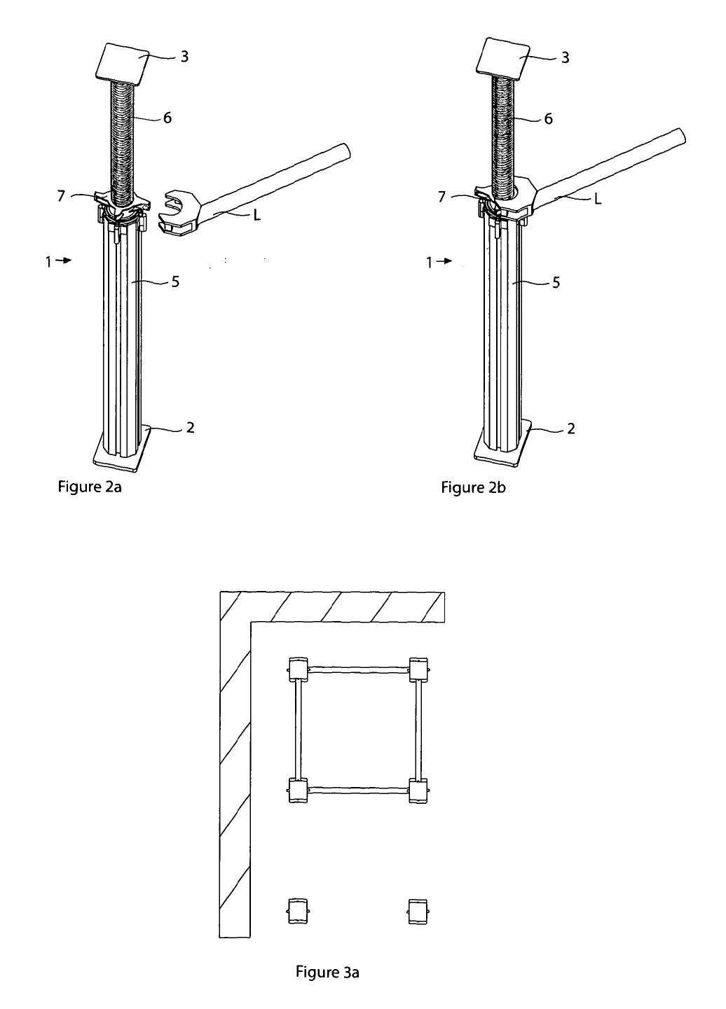

FIG. 1 shows a typical array of posts 1 used as falsework to support an edifice under construction. The posts 1 each have a metal foot 2 and a metal top plate 3 (not shown in FIG. 1 but visible in FIGS. 2a and 2b), and can be braced together laterally by ledgers or cross braces 4. Typically the top plates 3 would support mould M into which or onto which wet concrete is poured to create a reinforced concrete raft or beam as an integral part of the construction.

FIG. 2 is a detail of one such post 1. It comprises a hollow column portion 5 from which a screw jack portion 6 extends. A screw threaded nut (known in the trade as a collar) 7 is in screw threaded engagement with the screw jack portion 6, so that turning the collar 7 raises or lowers the top platform 3 relative to the base plate 2. The post 1 of FIG. 2 could be inverted so that the collar and screw threaded portion are at the bottom rather than at the top, or the post 1 could be provided with screw jack portions and collars at both the top and the bottom of the column portion 5. FIGS. 2a, 2b and 4 shown one typical design of collar 7 which has four outstanding lugs 8 of two different sizes and profiles. Together those lugs 8 are designed to be engaged by a specially designed spanner head of a lever arm L as shown in FIGS. 2a and 2b. The lever arm L is used to generate leverage on the collar 7 during striking, in order to overcome the frictional load imposed upon it by the weight of the construction it supports. Often even the extra leverage provided by the lever arm L is insufficient to overcome that frictional load manually, in which case the site worker might hit the remote end of the lever arm L repeatedly with a heavy hammer or sledgehammer until the collar 7 turns and releases that frictional load.

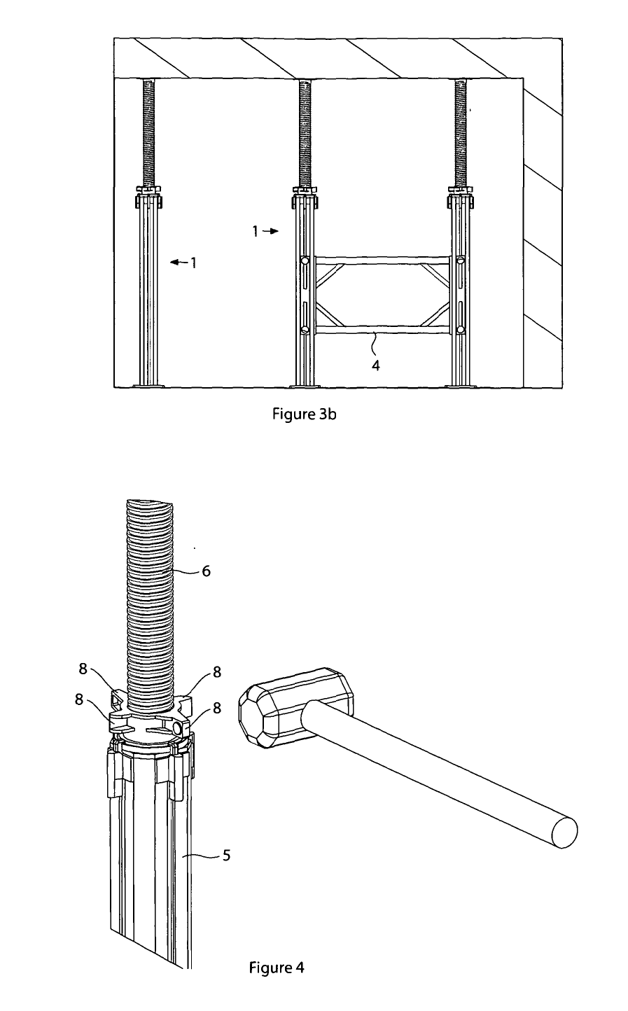

FIGS. 3a and 3b are respective plan and elevational views of part of a possible falsework location, illustrating how the posts 1 of the falsework may be close to one another or to walls of the construction being built. Those walls may therefore restrict the ability of the site worker to use the lever arm L, and may make striking of the falsework very difficult. Another scenario is that the site worker may need to be lifted closer to the falsework on the platform of a cherry-picker and may even have to lean out over that platform in order to access the collar during striking, which makes the striking both difficult and dangerous. Although not recommended practice, site workers in such situations often hit not the lever arm L but the collar 7 itself with a heavy hammer or sledgehammer during striking in order to release the collar 7. Such an action is shown schematically in FIG. 4, but causes damage to the collars 7 which can become bent or cracked. A further necessary part of all falsework erection is therefore a check on the collars for damage created during their last use.

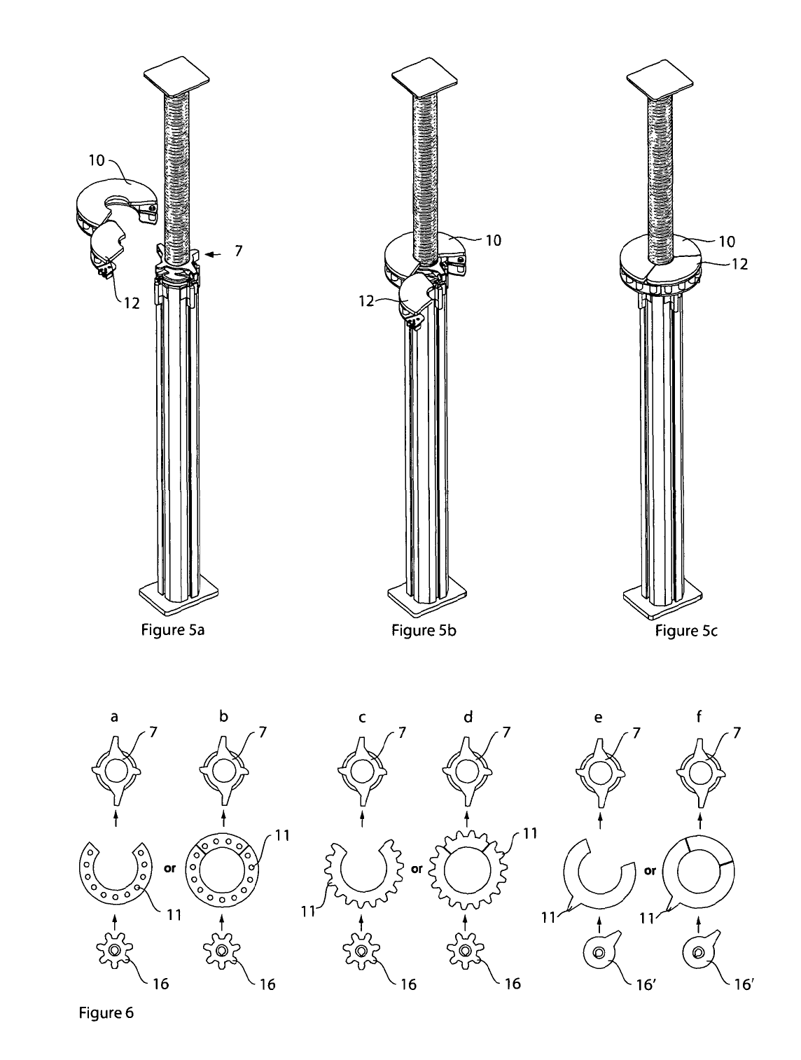

An element of the tool of the invention is a collar adapter 10, to engage with the motor drive, which can preferably close and lock around the screw collar 7 in driving engagement with the collar. One such collar adapter 10 is shown in FIGS. 5a to 5c. It is formed with a circular array of drive engagement elements 11 which lie at a greater distance from the axis of the post 1 than does the collar itself, so as to increase the leverage on the collar when the drive is engaged. The collar adapter 10 is hinged to open at 12, enabling it to be placed around the collar 7 and then be closed and locked, as shown in FIG. 5c.

Six alternative designs of collar adapter 10 are shown in FIGS. 6a to 6f. Those six designs demonstrate how the collar adapter may be of open or closed formation. The open shape designs of FIGS. 6a, 6c and 6e simply fit around the post 1 and collar 7 and must then be engaged with the collar lugs 8. The closed designs incorporate the hinged opening portion 12 illustrated in FIGS. 5a to 5c, and that hinged opening portion 12 is closed around the collar 1 when the adapter 10 is in position, to lock it onto the collar. One advantage of the closed design is that of greater security, as the adapter 10 is securely locked around the collar 7 and securely maintained in driving engagement with the collar 7 when the hinged opening portion 12 is closed and locked. Another advantage is that the drive engagement means 11, which may be composed of integral teeth 11 as in FIGS. 6c to 6f or rods spanning two parallel plates as in FIGS. 6a and 6b, may extend a full 360° around the axis of the post 1 in the closed design as opposed to a reduced angular extent in the open design. When the drive engagement means 11 extend fully around the post axis as in FIGS. 6b and 6d the collar may be turned for more than one revolution by the drive motor which is yet to be described, but that is not an essential consideration in a tool according to the invention. If the collar adapter 10 has only a single tooth or pawl or dog 11 as in FIGS. 6e and 6f, then during striking the collar can still be released by turning it for a fraction of a revolution using the drive motor, which may be sufficient to release the frictional load to an extent sufficient to permit continued turning by hand.

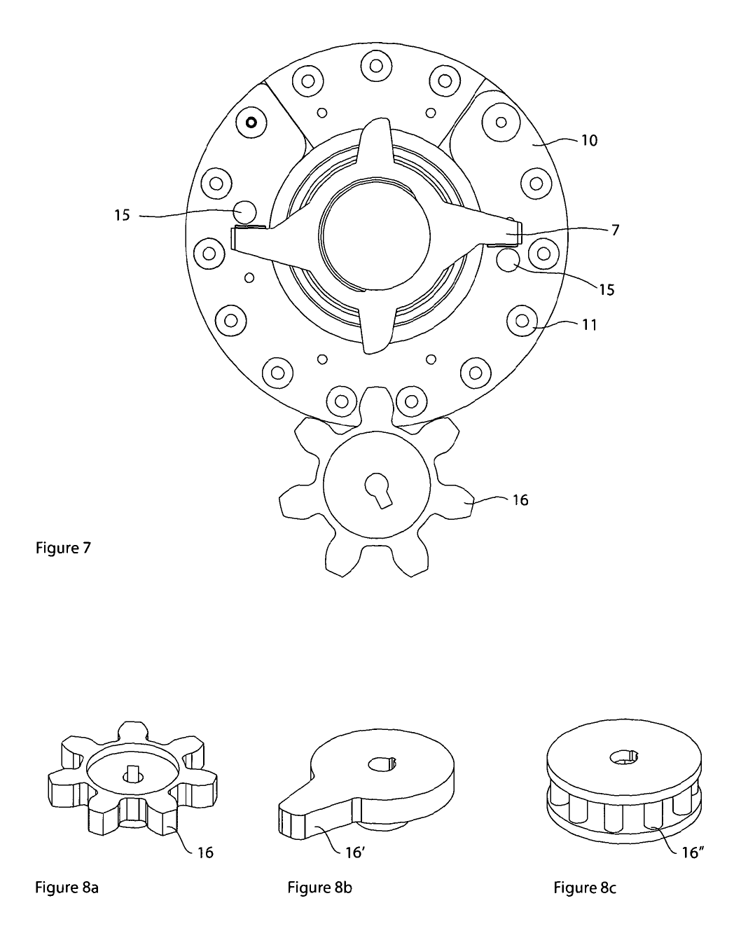

FIG. 7 illustrates the engagement between the collar 7, the collar adapter 10 with its drive engagement teeth 11 and a drive member 16 of a motor when the collar adapter 10 is closed and locked around the collar 7 and when the motor is presented in driving engagement with the collar adapter 10. The collar adapter 10 is provided with pillars 15 that engage the lugs 8 of the collar 7 in order to transmit torque thereto when the collar adapter 10 is rotated by the motor in the anti-clockwise direction as viewed in FIG. 7.

FIGS. 8a to 8c show three alternative forms of drive member 16. The drive member 16 may be a spur gear with an annular array of gear teeth as shown in FIG. 8a, or it may have only one gear tooth or pawl or dog 16′ as in FIG. 8b, or it may consist of two spaced parallel plates with a circular array of rod members 16″ spanning the gap between the plates as in FIG. 8c. The FIG. 8c construction could be used with a collar adapter 10 as shown in FIGS. 6c to 6f but not with one as shown in FIG. 6a or 6b.

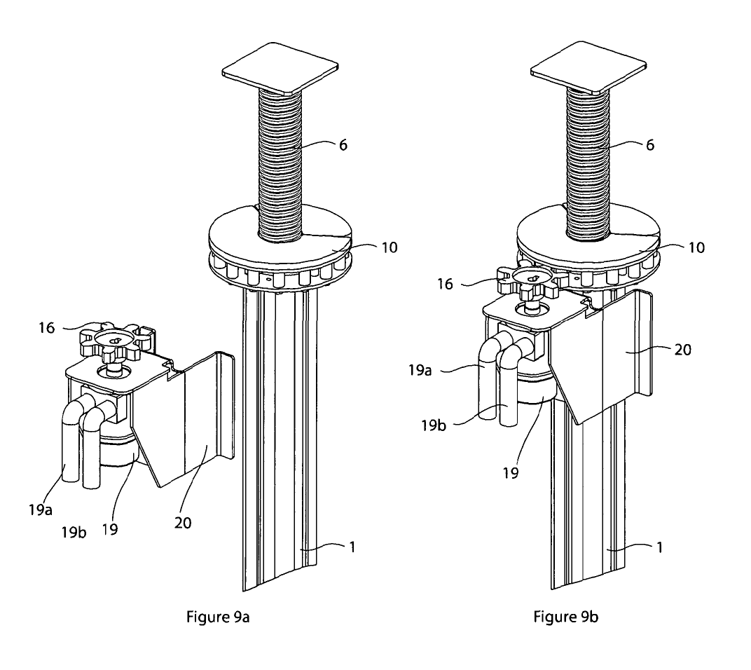

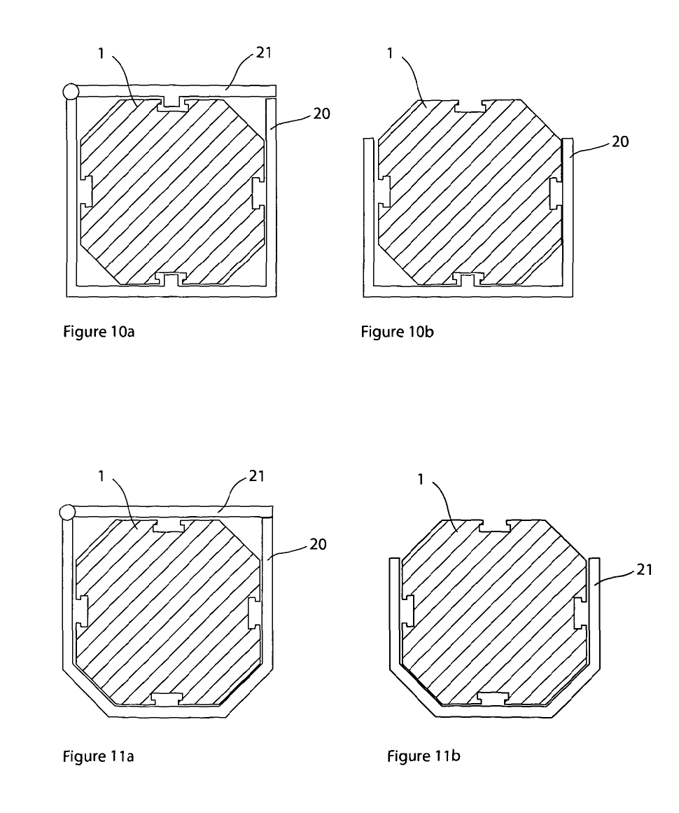

FIGS. 9a and 9b illustrate the collar adapter 10 of FIGS. 5a and 5b placed around the post 1 and collar 7 of falsework. Also shown is a motor housing 20 which can be presented up to the collar adapter 10 and then placed in position on the post 1. A motor 19 is shown as being carried by the motor housing 20, and is illustrated as a hydraulic motor with inlet and return hydraulic pipes 19a and 19b respectively. Various means of locking the motor housing to the post 1 are possible, ensuring that the motor housing takes its vertical and angular support from the post. FIGS. 10a and 11a show how the motor housing 20 can be formed with a door 21 which closes around the post 1. When the door is locked closed (by means not shown) the motor housing is securely anchored to the post 1 to resist both vertical and angular movement relative to the post. Alternatively the motor housing 20 may be formed without the door, as shown in FIGS. 10b and 11b. Angular support from the post 1 for reacting against the torque applied in use to the collar 7 is provided by either a projection on the motor housing 20 engaging with features of the post 1 as illustrated in FIGS. 10a and 10b or the entire motor housing 20 reacting against the overall post profile as illustrated in FIGS. 11a and 11b. The vertical support for the motor housing 20 with or without a door 21 can be achieved by having the motor housing 20 rest either on a stationary portion of the falsework or on the rotating surface of either the collar 7 or the collar adapter 10. Such vertical support of the motor housing 20 provided by the collar adapter 10 can be seen in FIG. 13 which is also relevant, mutatis mutandis, should the motor housing 20 not have a door 21.

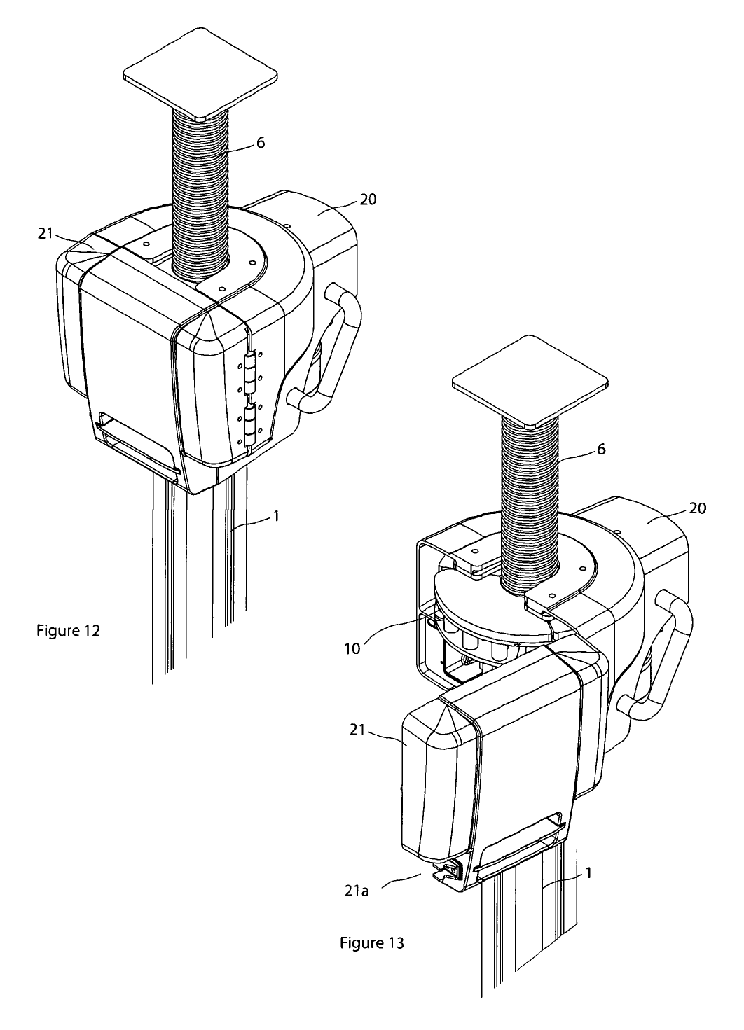

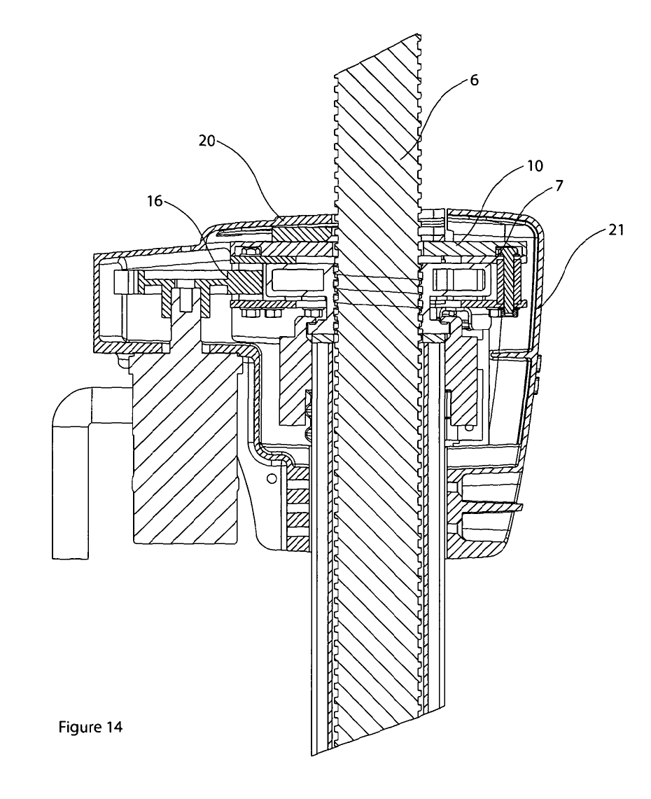

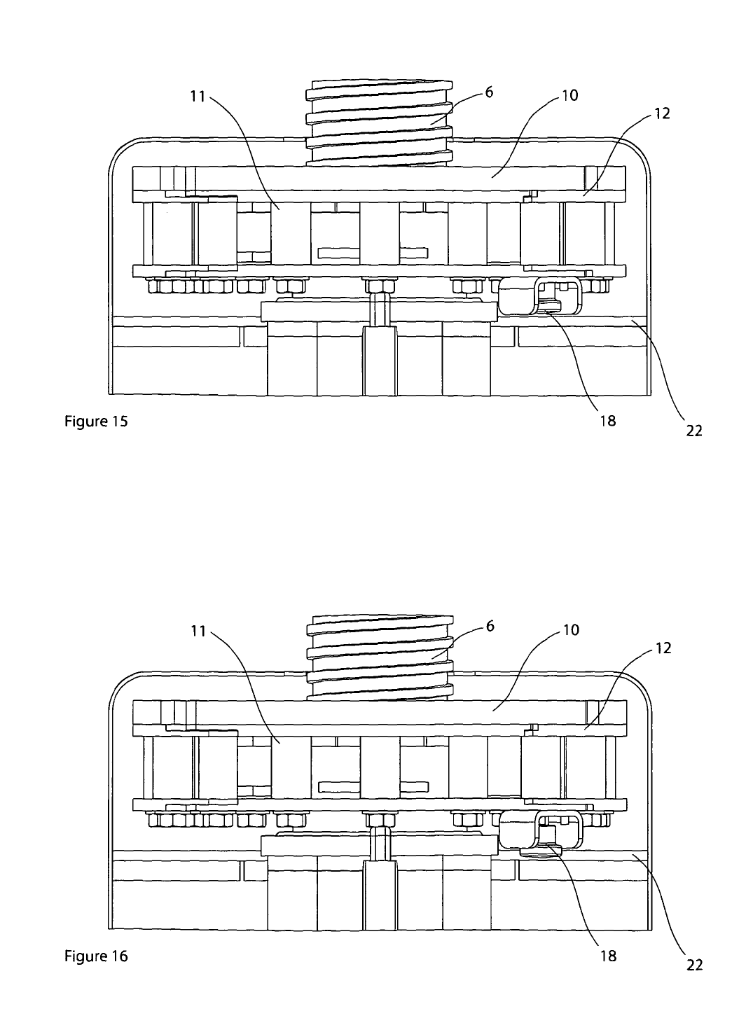

FIGS. 12, 13 and 14 illustrate one design of motor housing shown in greater detail than the schematic illustration of FIGS. 9a to 11b. The basic elements of the motor housing 20 are as already described. It has a housing body 20 and an access door 21. An important detail of the design of the collar adapter 10 and motor housing 20 is illustrated in FIGS. 15 and 16. The collar adapter 10 is provided with a hinged opening portion 12 as shown in FIG. 5a, which is movable between an open position enabling the collar adapter to pass around the collar 7 to surround the collar, and a closed and locked position in which the collar adapter is fast to the collar. The hinged portion 12 has a pivotal axis provided by one of the rod members 11 or by a pin passing axially through one of the rod members 11, and the means for locking the collar adapter 10 in its closed position comprises a spring-loaded locking index plunger 18 carried by the hinged portion 12 and engaging in a bore in one of the plate members or in one of the rod members when the hinged portion 12 is in its closed position. FIG. 15 shows how the motor housing 20 is secured onto the falsework post 1 when the index plunger 18 is fully received in its locking recess. If the index plunger 18 is not fully received in its locking recess, as illustrated in FIG. 16, then it will foul an interference surface 22 of a bottom plate portion of the motor housing 20 or of its access door 21. This ensures that the collar adapter 10 is fully closed and locked around the collar before it is concealed from sight by closing and locking the motor housing 20 around it. A latch mechanism (not visible in FIG. 13) engages with a latching anchorage member 21a which is visible in FIG. 13, securely to lock the motor housing 20 around the collar adapter 10 when the index plunger is fully engaged as in FIG. 16.

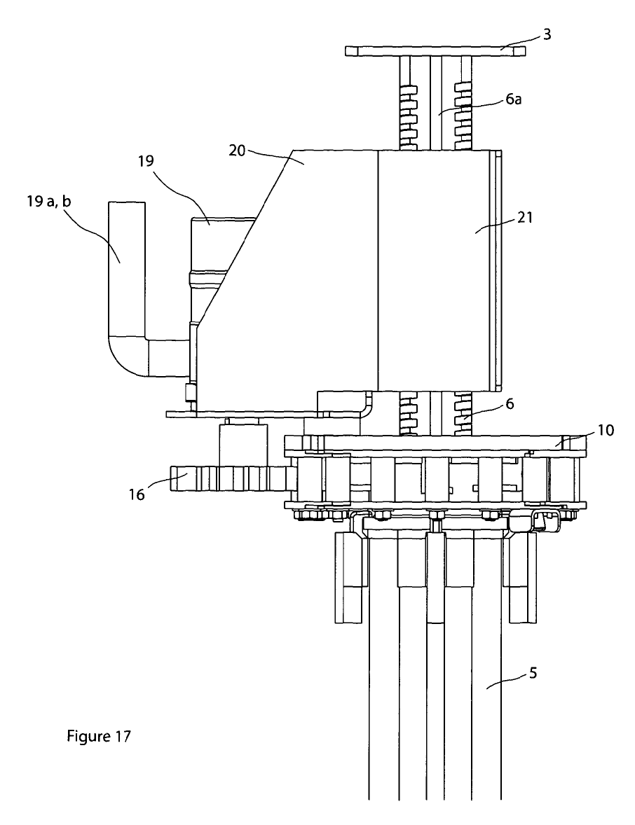

FIG. 17 shows an alternative embodiment in which the collar adaptor 10 is the same as that of FIGS. 9a and 9b, and the motor housing 20 and motor 19 are largely the same except that the motor and motor housing are shown in an inverted position relative to that shown in FIGS. 9a and 9b, and the motor housing 20 is mounted on the screw threaded portion 6 of the falsework. The motor housing 20 still takes its angular support from the post 1 because the screw threaded portion 6 is shown as including a keyway 6a which is keyed to an internally protruding portion of the hollow column portion 5 of the post 1, and the motor housing 20 is keyed to that same keyway 6a. An alternative arrangement in which the motor 19 and motor housing 20 could be in the inverted position of FIG. 17 would be one in which the motor housing was clamped directly to the profile of the hollow column portion 5 of the threaded post 1.

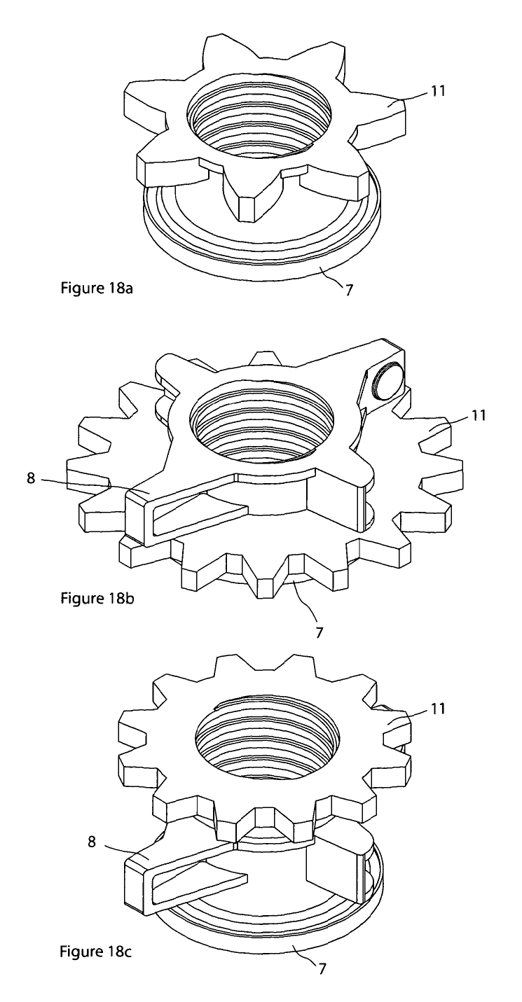

FIGS. 18a to 18c show alternative designs of collar 7 which have integral drive engagement means 11 in the form of integrally formed gear teeth 11. Such collars do not require the use of collar adapters as do the collars 7 of FIGS. 5 to 17. They thus provide for quicker tool operation at the expense of a larger and heavier collar

FIG. 18a shows a collar 7 which does not include the collar lugs 8 of the other illustrated embodiments of collars 7. The lugs are omitted because the collar 7 of FIG. 18a is designed to avoid the use of a torque bar L such as that illustrated in FIGS. 2a and 2b. FIGS. 18b and 18c include lugs 8 in alternative positions, and the collars of those two FIGS. can be rotated using either a torque bar such as that illustrated as L in FIGS. 2a and 2b or the motor 19 as taught above in relation to the invention.

In use, any of the tools as described above with reference to FIGS. 5a to 18c could be used during striking of falsework. For those tools which include a collar adapter 10, the collar adapter 10 would first be placed around the collar 7 of each in turn of the screw jacks of the falsework. Then the motor housing 20 would be presented up to both the hollow portion 5 or the screw threaded portion 6 of the post 1 and the collar adapter 10, and if appropriate closed around the post 1 and locked in its closed position. It should be understood that if the motor housing 20 does not include a door 21 or other means for locking the housing 20 around the post 1, it may be sufficient simply to hold the motor housing 20 in position while actuating the motor 19. The feature that the motor housing takes vertical support as well as angular support from the post is therefore an optional feature. When the motor housing 20 is in position against the post 1 it takes leverage from the post 1 of the falsework, so that when the motor 19 is actuated the collar 7 can be turned, relieving the pressure on the screw-threaded portion 5 of the falsework. By suitable choice of motor (which may be hydraulic, pneumatic or electrical and may if necessary include reduction gearing to augment the output torque) the torque that is exerted by the motor can be designed to be sufficient to turn collars even under the maximum of load, and the time taken to assemble the two components of the tool onto the falsework and actuate the motor is comparable with the time taken to fit and use a conventional spanner and torque bar as shown in FIGS. 2a and 2b. In restricted spaces, the tool of the invention provides a substantially more rapid striking of the falsework. Irrespective of access, the tool provides a safer and quieter operation for striking the falsework and eliminates damage to the falsework compared to currently the adopted procedure of imparting a striking force onto the collar, usually with a sledgehammer.

1. A tool for turning a screw collar on a falsework post, comprising:
a motor housing formed to pass partially or completely around the falsework post so as releasably to mount the motor housing on the post in engagement with a feature of the post such that it becomes angularly immovable relative to the post;
a motor carried by the motor housing; and
a drive member powered by the motor or by output from a motor/gearbox combination and, on actuation of the motor while the motor housing is mounted on the post, being adapted to come into driving engagement with a drive engagement means on or associated with the screw collar of the falsework post to turn the screw collar relative to the post through the drive engagement means.

2. A tool according to claim 1, wherein the motor is a hydraulic motor.

3. A tool according to claim 1, wherein the motor is a pneumatic motor.

4. A tool according to claim 1, wherein the motor is an electric motor.

5. A tool according to claim 1, further comprising a collar adapter releasably mounted on the screw collar, wherein the drive engagement means is formed on the collar adapter.

6. A tool according to claim 5, wherein the drive engagement means comprises at least one tooth, pawl or dog formed on the collar adapter.

7. A tool according to claim 5, wherein the drive engagement means comprises a circular array of gear teeth, pawls or dogs formed on the collar adapter, the array being centred on a vertical axis of the screw collar when the collar adapter is mounted on the screw collar.

8. A tool according to claim 7, wherein the collar adapter is formed to close and releasably to lock around the screw collar so that when it is closed and locked around the screw collar it partially or completely envelops the collar.

9. A tool according to claim 8, wherein the collar adapter includes a hinged portion which is movable between an open position enabling the collar adapter to pass around the collar to surround the collar, and a closed and locked position in which the collar adapter is fast to the collar.

10. A tool according to claim 9, wherein the collar adapter comprises a pair of mutually spaced parallel plates which are engageable above and below the collar and between which radially outwardly of the collar extend a rod member or an array of rod members which form the drive engagement means.

11. A tool according to claim 10, wherein the hinged portion has a pivotal axis provided by one of the rod members or by a pin passing axially through one of the rod members, and the means for locking the collar adapter comprises a spring-loaded plunger carried by the hinged portion and engaging in a bore in one of the plate members or in one of the rod members when the hinged portion is in its closed position.

12. A tool according to claim 11, wherein unless the spring-loaded plunger is fully engaged in the said bore following closure of the collar adapter around the collar, it provides an obstruction preventing the motor housing from passing partially or completely around the post and from engaging with the feature of the post to become angularly immovable relative to the post.

13. A tool according to claim 1, wherein the motor drive member is a spur gear.

14. A tool according to claim 1, wherein the motor housing includes a hinged portion which is movable to an open position enabling the motor housing to pass around the post of the falsework, and a closed and locked position in which the motor housing surrounds the post and engages with the feature of the post.

15. A tool according to claim 1, wherein the motor housing when mounted on the falsework post envelops the collar, avoiding exposure of moving parts.
